(19) United States
(12) Patent Application Publication
(10) Pub. No.: US 2019/0071151 A1
(43) Pub. Date: Mar. 7, 2019

(54) Viewing Window With Camera

(71) Applicant: Autz + Herrmann GmbH, Heidelberg (DE)

(72) Inventor: Florian Friedrich, Heidelberg (DE)

(21) Appl. No.: 16/117,836

(22) Filed: Aug. 30, 2018

(30) Foreign Application Priority Data
Sep. 1, 2017 (DE) 102017120138.6

(51) Int. Cl. B63B 19/02; G03B 17/08; G03B 17/56

(52) U.S. Cl. CPC B63B 19/02; G03B 2217/26; G03B 17/561; G03B 17/08

(57) ABSTRACT

The clear view screen includes two transparent disks, of which one is fixed and the other rotates. A camera (28), which in any case looks through the rotating disk (18), is arranged between the two disks or on the side of the fixed disk facing away from the space to be observed. The camera is supplied with power via the power supply unit of the driving device, so that continuous operation is also possible when the camera is arranged in a space not accessible for maintenance, for example between the first and second disks or between the first disk and an uninterrupted separating wall.

### RELATED APPLICATION(S)

This application claims the benefit of German Patent Application No. 10 2017 120 138.6, filed Sep. 1, 2017, the contents of which is incorporated herein by reference as if fully rewritten herein.

### TECHNICAL FIELD

The invention relates to a clear view screen, in particular for machine enclosures and also for other applications.

### BACKGROUND

Rotating viewing windows are frequently used to ensure being able to see through vision panels that are subjected to soiling and, in particular, splashing or gushing fluids, such as water, oil or the like.

Such a rotating viewing window is known from U.S. Pat. No. 3,188,700, for example, and is also known from DE 10 2008 045 793 A1.

The known viewing window comprises a round frame to be placed onto a viewing panel or to be inserted into an appropriate opening of the viewing panel. A fixedly arranged first disk, which centrally carries a bearing for a second, rotating disk, is provided in the frame. The rotating disk is arranged on the side of the round disk that is subjected to dirt or fluid. A drive for the rotating disk is accommodated in the annular frame of the arrangement. The drive is supplied with operating current via a cable.

It is also known from U.S. Pat. No. 3,188,700 to accommodate the drive of the rotating disk on the central bearing unit.

Fluid and dirt are thrown away from the rotating disk by way of a spinning action, so that a clear view is maintained as soon as the disk rotates sufficiently quickly.

Such clear view screens can be used, in particular, on machine tools where the cooling lubricant that is used in the working chamber and washes constantly or in a gushing manner against the viewing panels impairs the view through the viewing panel. The clear view screen allows the processing operations taking place in the working chamber to be observed.

In addition, a camera housing serving as protection against rain is known from DE 197 46 740 A1, which on the light entry side is closed by a rotatably mounted, driven clear view screen. The lens of the camera is arranged in the direct vicinity of the rotating disk. The optical axis of the camera runs through the rotating disk, so that the camera is able to record a clear picture even when impinging liquids act on the housing. Moreover, a battery for operating the motor of the rotating disk is accommodated in the rain protection housing of the camera.

It is the object of the invention to create a clear view screen that not only grants persons a view of an area to be observed, but also allows mechanical monitoring of the area to be viewed. In particular, the clear view screen is to be low-maintenance and suitable for continuous use.

### SUMMARY

This object is achieved by the clear view screen according to claim 1, which is suitable, in particular, for machine enclosures, but also for other applications.

The clear view screen according to the invention comprises a first transparent disk, which can be attached to a machine enclosure or another wall, in particular a transparent pane or the like. The first transparent disk is preferably designed and arranged so as to seal a potential opening provided in the separating wall in a fluid-tight manner, or at least in a manner that offers protection against splashing water. If the separating wall is transparent, the first transparent disk can also be placed onto the separating wall or be formed thereby.

The first disk carries a bearing device for a second disk, which is rotatably mounted and driven. A driving device is used for driving purposes, which preferably, but not necessarily, is designed as an electric drive. The driving device can be accommodated in a, preferably annular, housing that is arranged on the outer edge of the first disk. In this way, the centrally arranged bearing device can have a slim design, which is to say have an outer radius that is small compared to the radius of the rotatably mounted disk, thereby exposing a large field of vision.

A camera is arranged on one side of the first disk, the lens thereof having a viewing direction that runs through the second disk. The camera preferably has outside dimensions that are smaller than the outside dimensions of the bearing device. The unobstructed view through the clear view screen is thus not impaired. It is not only possible for persons to view the region to be observed, but also to carry out camera recordings or camera monitoring.

For energy supply purposes, the camera is connected to the driving device. In this way, it is possible to continuously operate the camera without replacing a battery. Furthermore, sufficient operating power is provided so as to enable radio-based data transmission from the camera to an outside receiver without difficulty, even over extended ranges and in an environment subject to electromagnetic interference.

If the driving device is an electric driving device, the camera can be connected to the driving device in that the camera is connected to the energy supply system, for example a supply cable, which supplies operating power to the driving device, and thus also the camera. However, it is also possible to connect the camera to the rotating disk, and thus ultimately to the driving device, by way of an alternating magnetic field. If one or more permanent magnets are arranged on the disk, which revolve together with the disk, and if induction coils are arranged on the image recording device, the operating voltage necessary for supplying the camera with power can be regeneratively generated from such coils. The permanent magnets may form part of the electric drive connected to the disk.

The camera is preferably held on a carrier, which extends from the annular housing inwardly in a radial direction. The carrier can form a cantilevered tongue or can be arranged to as to rest against the second disk. It is possible to arrange the camera on the side of the first disk facing the second disk and on the side of the first disk facing away from the second disk. The camera is preferably permanently installed and no access thereto is provided for an operator. However, it is protected to a high degree both mechanically and against fluids. This applies in particular when it is arranged in a space through which sealing air flows. A separate camera protective housing, which would enclose the carrier and the camera itself, which is to say the entire image recording system for operating the camera, is not present.

The camera can be rigidly attached to the carrier. As an alternative, it can be connected to the carrier via a spring and/or damper device. Such a flexible and damping device can be a spring-loaded universal joint, for example, which together with the camera establishes a mechanical resonant frequency that is preferably outside, and in particular below, a frequency spectrum of excitation frequencies that are transmitted as oscillations to the clear view screen.

The connection of the camera to the electric driving device preferably takes place only by way of two connecting lines of the camera, which are connected to connecting terminals of the driving device. This supplies the driving devices and the camera with operating power via the same supply line. The driving device and the camera can include electronic circuits for this purpose, which, from the electrical power supplied via the cable, conduct the respective voltages and currents suitable for operating the camera and the driving device, and decouple these from one another.

As an alternative, the camera can be supplied with energy by the electric or magnetic stray field of the electric driving device, and can thus be connected via the stray field to the driving device. For example, as described above, permanent magnets connected to the circumference of the rotating disk can generate alternating magnetic fields, which are collected and utilized by induction coils, on the camera arranged in the vicinity of the outer circumference of the rotating disk, or the operating circuit thereof. This solution is also practicable with clear view screens driven by compressed air, in which the rotatably mounted disk carries at least one permanent magnet for supplying the camera with power.

### BRIEF DESCRIPTION OF THE DRAWINGS

Refinements and modifications of the clear view screen according to the invention are the subject matter of the drawings, the description or claims. In the drawings:

FIG. 1 shows the clear view screen according to the invention in a simplified perspective illustration;

FIG. 2 shows a longitudinal sectional illustration of the clear view screen according to the invention;

FIG. 3 shows a detail of the clear view screen with a viewing direction into the space to be observed, hiding parts of the clear view screen to illustrate the drive thereof;

FIG. 4 shows a sectional view of the clear view screen with a viewing direction out of the space to be observed, with the rotatable disk removed;

FIG. 5 shows a sectional view of the clear view screen according to FIG. 2;

FIG. 6 shows the camera, and the carrier thereof, associated with the clear view screen according to the above figures, in a perspective view;

FIGS. 7 and 8 show modified embodiments of the clear view screen, in schematic vertical sectional illustrations.

### DETAILED DESCRIPTION

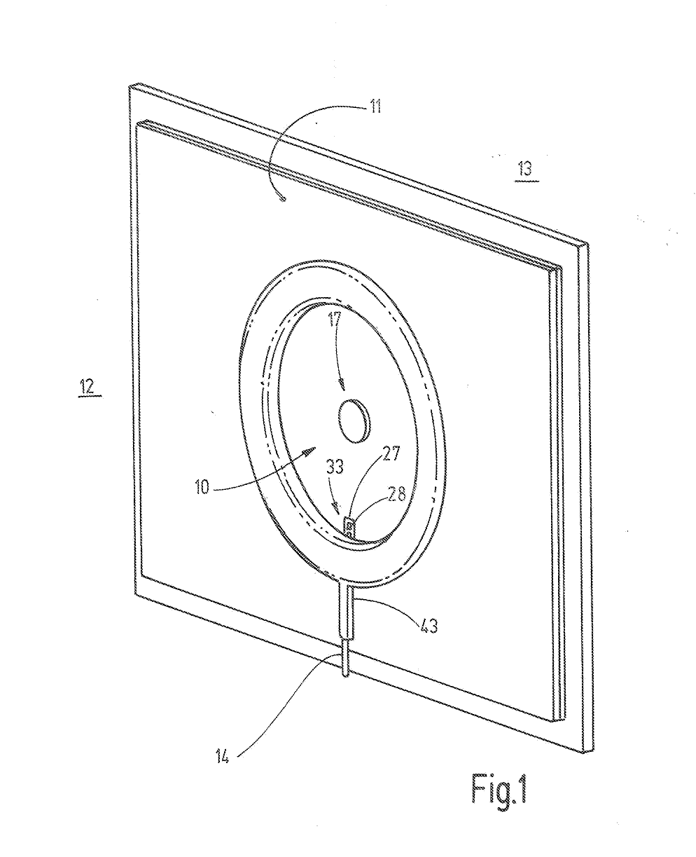

FIG. 1 illustrates a clear view screen 10, which is provided on a separating wall 11 designed to be transparent, for example, which separates a space 12 to be observed that is acted upon by dirt or fluid from an observer space 13, in which persons can be present. So as to grant a view of the space 12 to be observed to such persons even when liquids find their way onto the separating wall 11 due to splashing or gushing, the clear view screen 10 is provided, which creates a clear view by way of a spinning action. A cable 14 is provided to supply the clear view screen 10 with energy.

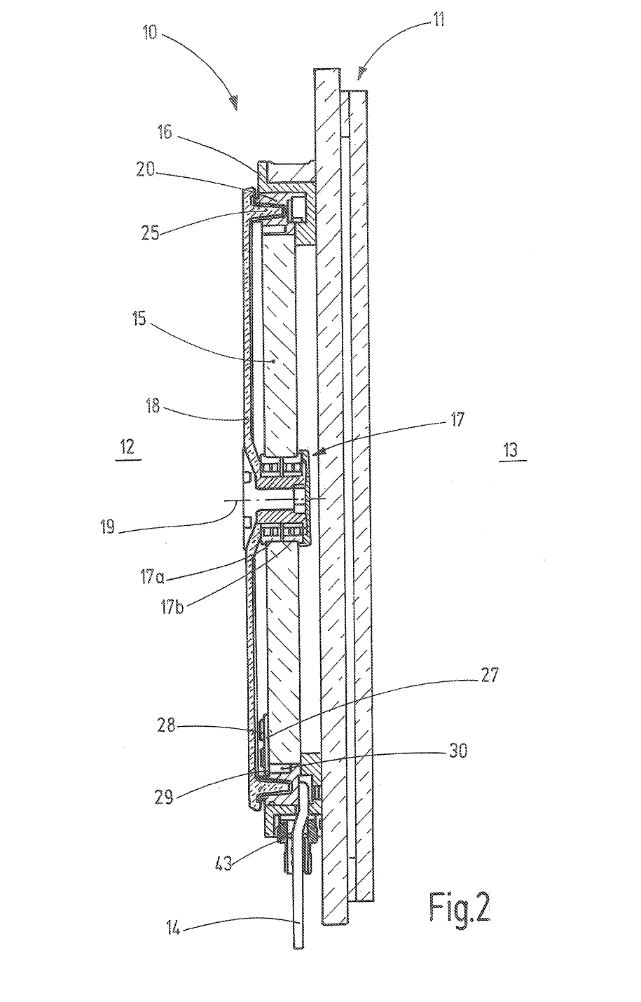

The composition of the clear view screen 10 can essentially be derived from FIG. 2. As is apparent, the clear view screen 10 is placed as a separate device onto the separating wall 11, which by way of example is shown as a double-walled separating wall, and is connected thereto. The clear view screen 10 includes a first disk 15, which is fixedly arranged on the separating wall 11 and preferably has a circular outer circumference, which is accommodated in an annular housing 16. The housing 16, in turn, is connected to the separating wall 11, for example bonded thereto, and holds the disk 15 at a fixed distance from the separating wall 11.

The first disk 15 carries a bearing device 17 for a second disk 18 so as to hold the same at a distance from the first disk 15 and mount it rotatably about a center line 19. The center line 19 is preferably also the center line of the first disk 15, so that the two disks 15, 18 are arranged concentrically with respect to one another, and preferably parallel to one another. The bearing device 17 preferably comprises one or more rolling bearings 17a, 17b, so that the second disk 18 can be easily rotated about the axis of rotation 19.

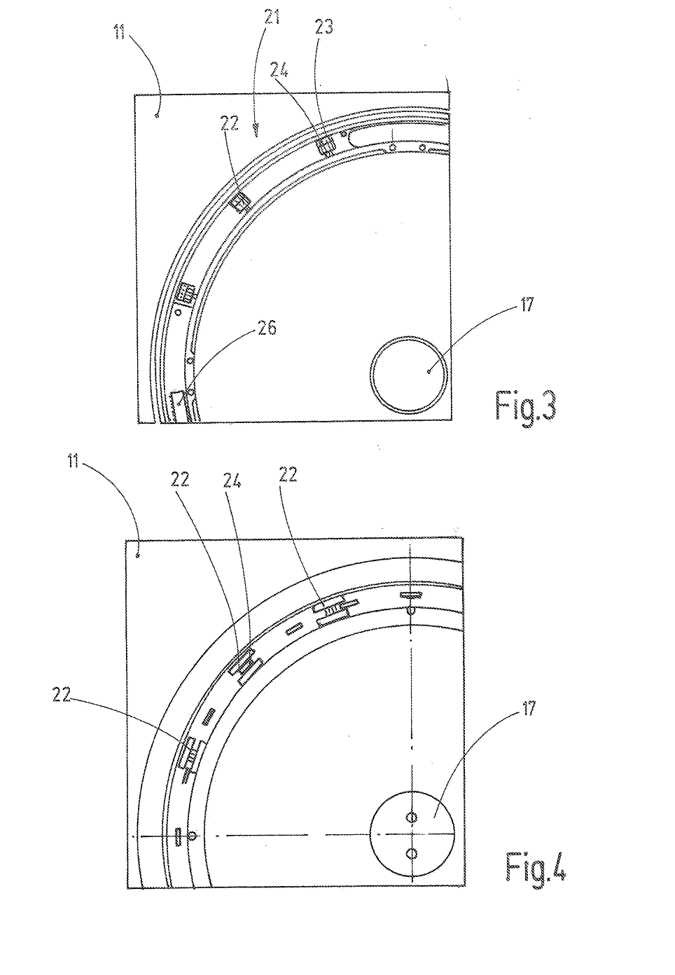

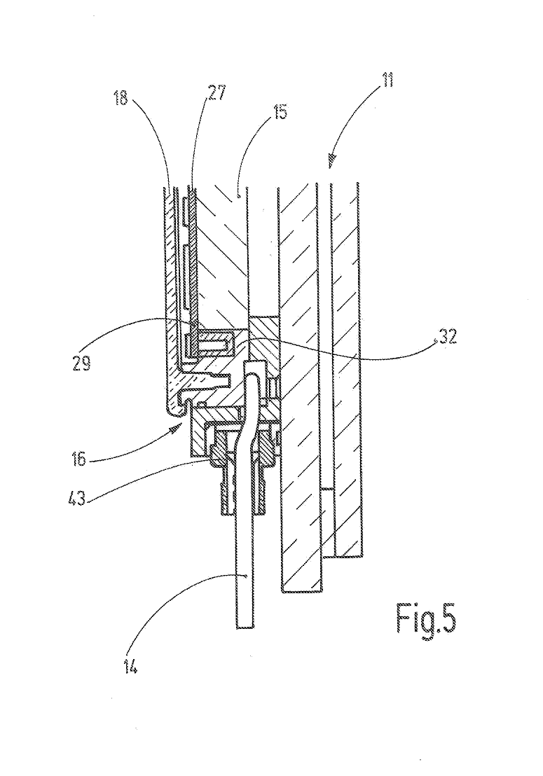

FIGS. 3 and 4 show the composition of a driving device 20, which is used to rotate and drive the second disk 18. The driving device 20 comprises a coil system 21, including a coil core 22, winding bodies 23 arranged thereon and coils 24. The coil system 21 defines an annular slot, which is concentric with respect to the axis of rotation 19 and into which an annular, rib-shaped protrusion 25 projects, which is provided with one or more permanent magnets and which is arranged concentrically with respect to the axis of rotation 19 and attached to the second disk 15. Instead of the permanent magnets, it is also possible for electrically conductive non-magnetic materials, such as an aluminum ring, or a combination of non-magnetic and soft magnetic materials to be provided, so as to form an eddy current drive according to the principle of the asynchronous machine, or soft magnetic or hard magnetic materials, such as a steel ring, so as to form a drive in the manner of a hysteresis motor. The driving device 20 furthermore includes a control circuit 26, which is schematically indicated in FIG. 3 and configured to conduct current pulses for the coils 24 from the voltage supplied via the cable 14, which cause a rotation of the second disk 18.

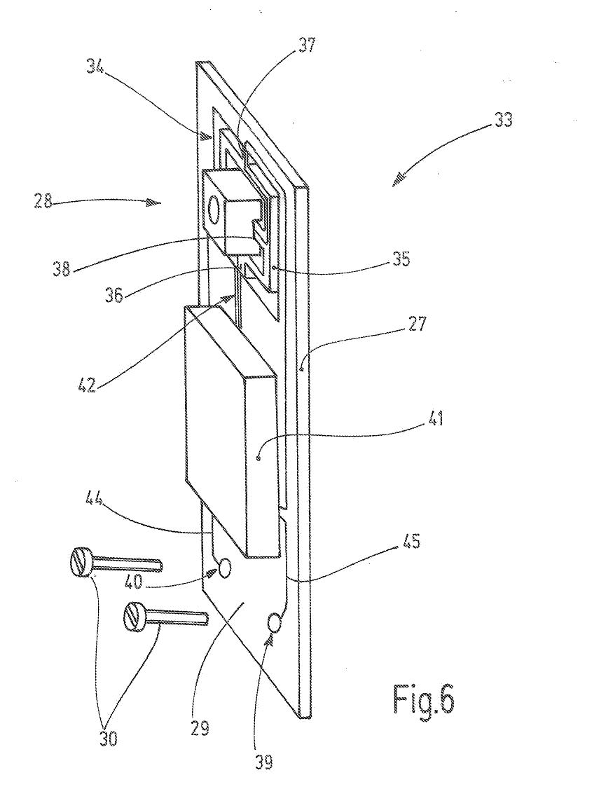

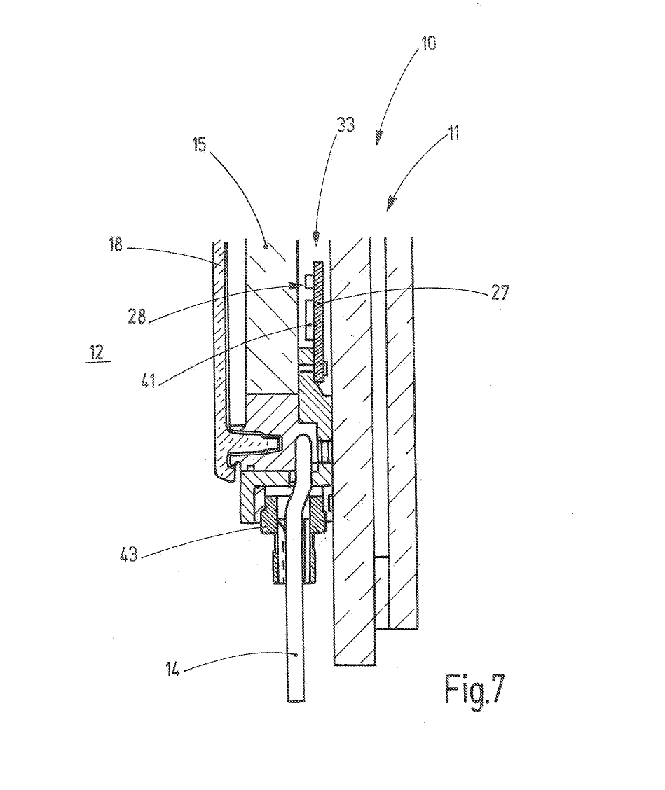

As is furthermore apparent from FIG. 2, a camera 28 is held on the housing 16 by way of a carrier 27, the viewing direction of the camera being directed through the second disk 18 into the space 12 to be observed (see also FIG. 1). Reference is made to FIGS. 5 and 6 for the further description. The carrier 27 can be a tongue-shaped carrier, which is arranged at a small distance from the first disk 15 or is arranged so as to rest thereon in some areas or across the entire surface. The carrier 27 is preferably only connected at the radially outer end 29 thereof to the annular housing 16. At the end 29, the carrier 27 is connected to the housing 16, for example by way of two screws 30, and is also electrically contacted. The two screws 30 are screwed into contact sockets 32, which are embedded in the housing 16 and electrically connected to two cores of the cable 14.

The portion of the housing 16 receiving the socket 32 can, for example, be made of an electrically insulating material, such as plastic material, or can comprise plastic inserts that receive the contact sockets 32. The cable 14 is connected to the housing 16 by way of a screw joint 43, a terminal box or the like. At the same time, the at least two cores of the cable 14 are connected to the control circuit 26 of the driving device 20 so as to supply both the camera 28 and the driving device 20 with electric energy. As an alternative, the cable can also comprise more than two cores to supply both the camera and the driving device 20 with energy. As another alternative, two or more jointly routed cables may be provided, instead of one cable. The cable can be a bus cable, via which energy is supplied to both the driving device and the image recording device 33. The bus cable can, alternatively or additionally, also be configured to transmit control pulses, for example activation and deactivation pulses for the camera 28 or the driving device, actuating pulses for an actuator of the camera 28 and/or image or video data.

FIG. 6 illustrates further optional details of the image recording device 33 formed by the camera 28 and the carrier 27 thereof. For example, the camera 28 can be held on the carrier 27 via a spring and damping device 34, which is designed, for example, in the manner of a universal joint comprising an intermediate ring 35, which is mounted on the carrier 27 so as to be pivotable about a first axis of rotation, which in FIG. 6 is vertical, via two flexible webs 36, 37. The camera 28 can then be mounted pivotably about an axis of rotation transverse thereto via further flexible webs, of which only one flexible web 38 is visible in FIG. 6. The flexible webs allow pivoting of the optical axis of the camera 28 in a conical region about the fixed axis, which is perpendicular to the two pivot axes defined by the flexible webs 36 to 38. Preferably, the mass inertia of the camera 38 and the elasticity of the flexible webs 36 to 38 establish a natural frequency that is below the excitation frequencies transmitted via the separating wall 11 to the clear view screen 10. The carrier 27 and the camera 28 are preferably arranged outside any of the fields, in particular magnetic fields, caused by the driving device 20. In this way, it is possible to independently achieve particularly steady mounting of the camera 28, whereby the potential of high resolution cameras can be better utilized.

The camera 28 can be supplied with power via flexible lines or via conductor tracks 44, 45, which extend across the flexible webs 36 to 38 and the intermediate ring 35 and lead to attachment openings 39, 40 for receiving the screws 30, 31. The conductor tracks 44, 45 can also connect the camera 28 to further circuit components.

For power conditioning, the carrier 27 can be provided with an operating circuit 41, which filters, smooths, decreases or increases the voltage supplied via the screws 30, 31 and conductor tracks 44, 45.

The camera 28 can include means suitable for wirelessly transmitting recorded images. As an alternative, such wireless transmission means may be part of the operating circuit 41. In the latter case, one or more lines 42 lead from the camera 28 to the operating circuit 41. The lines 42, in turn, can be conducted across the intermediate ring 35 and the flexible webs 36, 37, 38. This is only schematically indicated in FIG. 6.

The described clear view screen 10 operates as follows:

During operation, the clear view screen 10 receives electrical power, in the form of DC or AC current, with a substantially defined voltage via the cable 14. The particular voltage is applied to the control circuit 26 on the one hand and, via the screws 30, to the operating circuit 41 on the other hand. The control circuit 26 brings about an activation of the coils 24, whereby the second disk 18 is caused to rotate quickly. At the same time, the camera 28 is activated via the operating circuit 41, which records images, videos or video sequences and makes these available via the wireless interface, for example a WLAN interface. The rotatable disk 18 keeps the viewing region free, both for persons present in the observer space and for the camera 28. Due to the small dimensions of the camera 28, the camera does not impair the view. This holds true, in particular, when the dimensions of the image recording device 33 are smaller than the dimensions of the bearing device 17.

Where necessary, the spring and damping device 34 can also be designed as an angle setting device. Accordingly, the flexible webs 36, 37, 38 can be provided with actuators, for example piezo actuators, or be designed as actuators themselves. These actuators can be activated by the operating circuit 41, for example automatically or in accordance with received wireless commands, so as to align the camera 28 with regions of interest in the space 12 to be observed.

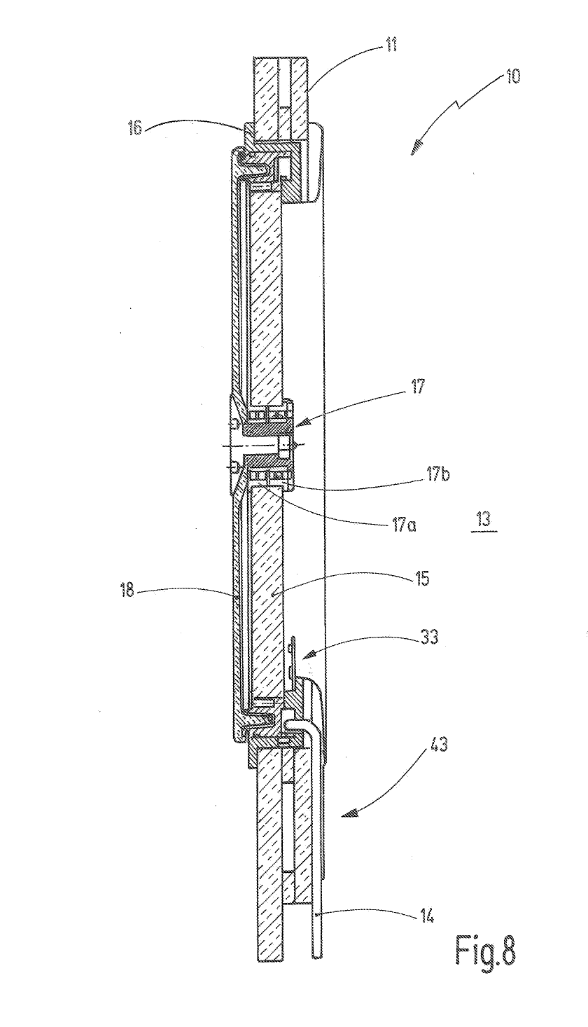

FIG. 7 illustrates a modified embodiment of the clear view screen 10 according to the invention, wherein reference is made to the above description for the explanation of the composition and the operating principle, referencing the introduced reference numerals. However, deviating from the above description, the image recording device 33 is not arranged on the side of the first disk 15 facing the space to be observed, but on the side thereof facing away from the space 12. The comments provided above apply accordingly with respect to the contacting, power supply and arrangement of the carrier 27. Additionally, it applies that the carrier 27 can be arranged both so as to rest against the separating wall 11, and, as is shown, spaced apart therefrom.

Another modified embodiment of the clear view screen 10 is apparent from FIG. 8. In this embodiment, the separating wall 11 is provided with a cut-out in which the clear view screen 10, together with the housing 16 thereof, is attached. As shown, the image recording device 33 can be arranged on the side of the first disk 15 facing the observer space 13 or, alternatively, in accordance with the embodiment from FIGS. 1 and 2, between the first disk 15 and the second disk 18.

It is pointed out that the invention is not limited to clear view screens 10 comprising a driving device that is accommodated on the housing side. Rather, the rotary drive of the disk 18 may also be arranged in or on the bearing device 18, wherein the cable used to supply power then extends across the first disk 15, from the outside, to the center with the bearing device 17 and the driving device. In this case, the cable can be present on or in a carrier, which also carries the image recording device 33.

The clear view screen according to the invention comprises two transparent disks, of which one is fixed and the other rotates. A camera 28, which in any case looks through the rotating disk 18, is arranged between the two disks 15, 18, or on the side of the fixed disk 15 facing away from the space 12 to be observed. The camera 28 is supplied with power via the power supply unit of the driving device 20, so that continuous operation is also possible when the camera 28 is arranged in a space not accessible for maintenance, for example between the first and second disks or between the first disk and an uninterrupted separating wall.

Reference numerals:

| | |
|---|---|
| 10 | clear view screen |
| 11 | separating wall |
| 12 | space to be observed |
| 13 | observer space |
| 14 | cable |
| 15 | first disk |
| 16 | housing |
| 17 | bearing device |
| 17a, b | rolling bearing |
| 18 | second disk |
| 19 | axis of rotation |
| 20 | driving device |
| 21 | coil system |
| 22 | coil core |
| 23 | winding body |
| 24 | coils |
| 25 | protrusion |
| 26 | control circuit |
| 27 | carrier |
| 28 | camera |
| 29 | end of carrier 27 |
| 30 | screws |
| 32 | contact sockets |
| 33 | image recording device |
| 34 | spring and damping device |
| 35 | intermediate ring |
| 36, 37, 38 | flexible webs |
| 39, 40 | attachment openings |
| 41 | operating circuit |
| 42 | lines |
| 43 | connecting housing |
| 44, 45 | lines |

1. A clear view screen (10) comprising:
a first transparent disk (15);
a second transparent disk (18);
a bearing device (17) that is held on the first disk (15) and connected to the second disk (18) so as to hold the second disk at a distance from the first disk (15) and rotatably mount the second disk;
a driving device (20) that is held on the first disk (15) and connected to the second disk (18) so as to rotatably drive the second disk (18) and includes a connection for energy supply (14); and
a camera (28), which is arranged on one side of the first disk (15) and comprises a lens having a viewing direction directed through the second disk (18), the camera (28) being connected to the clear view screen (10) for energy supply purposes.

2. The clear view screen according to claim 1, wherein the driving device (20) comprises a control circuit (26), which is accommodated in an annular housing (16).

3. The clear view screen according to claim 2, wherein the annular housing (16) is arranged concentrically with respect to the bearing device (17) and houses the driving device (20).

4. The clear view screen according to claim 2, wherein the camera (28) is arranged on a carrier (27) which, starting from the housing (16), extends inwardly in a radial direction.

5. The clear view screen according to claim 4, wherein the carrier (27) is held on the housing (16) and arranged so as to extend at a distance from the first disk (15).

6. The clear view screen according to claim 4, wherein the carrier (27) is held on the housing (16) and arranged so as to rest against the first disk (15).

7. The clear view screen according to claim 1, wherein the camera (28) is arranged on a side of the first disk (15) facing the second disk (18).

8. The clear view screen according to claim 1, wherein the camera (28) is arranged on a side of the first disk (15) facing away from the second disk (18).

9. The clear view screen according to claim 1, wherein the camera (28) is connected to the driving device (20) for energy supply purposes.

10. The clear view screen according to claim 1, wherein a cable (14) is provided for supplying the camera (28) and the driving device (20) with energy, the cable being connected in a connecting housing (43).

11. The clear view screen according to claim 10, wherein the camera (28) is arranged on a carrier (27), which carries electrical connecting lines (44, 45) and is connected to the connecting terminals and held mechanically, the connecting lines (44, 45) being electrically connected to the connecting terminals.
